(19) United States
(12) Patent Application Publication
(10) Pub. No.: US 2008/0179184 A1
(43) Pub. Date: Jul. 31, 2008

(54) Analyzing samples having diverse analytes in presence of salt using chromatography and evaporative light scattering detection

(76) Inventors: Hok-Kin Choi, San Jose, CA (US); Yongmei Wu, San Jose, CA (US); Vani Thirumala, San Jose, CA (US)

Correspondence Address: INTEL/BLAKELY, 1279 OAKMEAD PARKWAY, SUNNYVALE, CA, 94085-4040, US

(21) Appl. No.: 11/698,714

(22) Filed: Jan. 25, 2007

(51) Int. Cl. C25B 9/00; G01N 30/84

(52) U.S. Cl. 204/242; 73/61.55

(57) ABSTRACT

Methods of chemical analysis are disclosed. In one aspect, a method may include introducing a sample into a chromatograph. The sample may include a multiple analytes having diverse sizes and chemical properties. The analytes may be present in solution with a salt. The salt may have a concentration that is higher than that of each of the analytes. The analytes and the salt may be separated with the chromatograph. The separated analytes may be introduced into an evaporative light scattering detector (ELSD). The amounts of each of the analytes in the sample may be determined with the ELSD. Other methods, including methods of analyzing plating solutions and adjusting the plating solutions based on the analysis are also disclosed, as are systems to perform such analysis and systems to adjust the concentrations of plating solutions.

### BACKGROUND

1. Field

Embodiments of the invention relate to chemical analysis. In particular, embodiments of the invention relate to analyzing samples having diverse analytes in the presence of salt using chromatography and evaporative light scattering detection.

2. Background Information

Plating solutions, such as, for example, electroplating solutions and electroless plating solutions, are widely used in the microelectronic device fabrication arts to form interconnect structures. By way of example, a representative electroplating solution may include a plating metal salt, such as, for example, a copper salt, an acid, and one or more chemical additives, such as, for example, an accelerator, a leveler, and a suppresser.

It is generally desirable to maintain the concentrations of the plating metal salt, the acid, and each of the chemical additives at their substantially constant, intended concentrations in order to promote good plating performance and consistency. However, the concentrations may potentially change over time due to such factors as a chemical being incorporation into the plated metal, formation of by-products, sorption to surfaces or materials, and various other factors. A significant change in a concentration may result in a change in the rate of plating and/or a change in the physical characteristics of the plated metal. In some cases, a significant change in a concentration may result in an increase in the number of defective microelectronic devices.

As such, the concentrations of the components of the plating solution may be monitored regularly as part of a quality control effort. However, monitoring the concentrations of the chemical additives tends to be challenging. For one thing, the concentrations of the chemical additives are often significantly lower than the concentration of the plating metal salt and/or acid, and the plating metal salt and/or acid may interfere with accurate measurement of the concentrations of the chemical additives due to a matrix effect. For another thing, the chemical additives may have substantially different sizes and/or chemical properties. For example, the accelerator may be a small organic salt or compound, such as, for example, a bisulfonate, alkyl sulfonate, pyridine, or derivative of one of these compounds, and the leveler may be a relatively large, non-ionized organic polymer, such as, for example, a polyamine, polyamide, polyimine, or derivative of one of these compounds. Such different sizes and/or chemical properties may make it challenging to measure the concentrations of all of the chemical additives using a single, relatively rapid technique that is suitable for process monitoring. Furthermore, detecting or measuring the concentrations of by-products of the chemical additives similarly tends to be challenging. For example, even if all of the chemical additives may be detected using ultraviolet radiation based detectors, all of the by-products may not.

One possible approach for managing the uncertain concentrations of the chemical additives in a plating solution is simply to discard the plating solution at relatively frequent intervals. For example, the plating solution may be discarded daily in order to ensure that the concentrations of the chemical additives in the plating solution do not change too much. This may help to avoid an increase in the number of defective devices produced by the plating process. However, this approach tends to be costly and the discarded solutions may need environmental treatment.

Alternate methods and apparatus to determine the amounts of multiple, diverse analytes in the same sample in the presence of a relatively high concentration of a salt, acid, or other component providing a matrix affect, may therefore offer certain potential advantages.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block flow diagram of a method of analyzing a sample, according to one or more embodiments of the invention.

FIG. 2A conceptually illustrates separation of components in a liquid chromatography column, according to one or more embodiments of the invention.

FIG. 2B is a chromatogram showing elution of components at different times from a chromatograph, according to one or more embodiments of the invention.

FIG. 3 is a block flow diagram illustrating a method of evaporative light scattering detection (ELSD), according to one or more embodiments of the invention.

FIG. 4 is a sectional perspective view of a simplified illustrative evaporative light scattering detector (ELSD), according to one or more embodiments of the invention.

FIG. 5 is a chromatogram showing determined amounts of components of a plating solution, according to one or more embodiments of the invention.

FIG. 6 is a block flow diagram illustrating a method of adjusting concentration(s) of a plating solution based on sample analysis, according to one or more embodiments of the invention.

FIG. 7 is a block diagram of a system to analyze and adjust concentration(s) of a plating solution, according to one or more embodiments of the invention.

### DETAILED DESCRIPTION

In the following description, numerous specific details are set forth. However, it is understood that embodiments of the invention may be practiced without these specific details. In other instances, well-known structures and techniques have not been shown in detail in order not to obscure the understanding of this description.

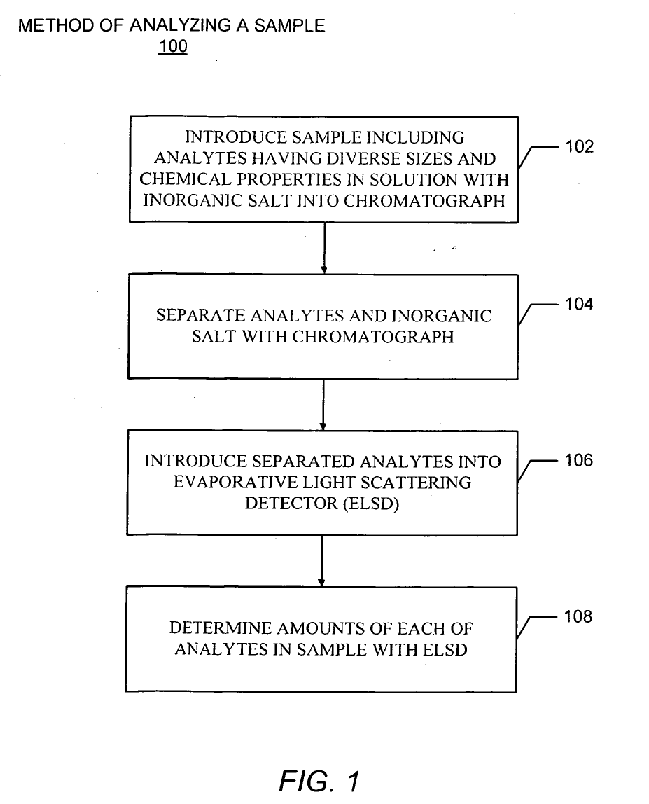

FIG. 1 is a block flow diagram of a method of analyzing a sample 100, according to one or more embodiments of the invention. The method is shown in basic form, although additional operations may optionally be added to the method.

Initially, the sample may be introduced into a chromatograph, at block 102. As previously mentioned, in one or more embodiments of the invention, the sample may include a sample of a plating solution, such as, for example, an electroplating solution or an electroless plating solution.

The sample of the plating solution may include a salt of a plating metal, an acid, and a plurality of chemical additives. In one or more embodiments of the invention, a concentration of the plating metal salt may be higher than respective concentrations of each of the chemical additives. In one or more embodiments of the invention, the salt may have a concentration of at least about 0.05 mol/L. For example, a concentration of copper sulfate may be employed in the range of 0.1 to 0.4 mol/L, or higher. Such a high salt concentration, if not separated out, would otherwise tend to make accurate concentration measurement of the chemical additives difficult.

Examples of chemical additives that may be used in plating solutions include, but are not limited to, accelerators, levelers, suppressers, and combinations thereof. Examples of suitable accelerators include, but are not limited to, bisulfonates and derivatives thereof, alkyl sulfonates and derivatives thereof, and pyridine and derivatives thereof. Examples of suitable levelers include, but are not limited to, polyamides and derivatives thereof, polyamines and derivatives thereof, and polyimines and derivatives thereof. Examples of suitable suppressers include, but are not limited to, polysilyl complexes and derivatives thereof, polyether complexes and derivatives thereof, and polycyclic macrolyte complexes and derivatives thereof. Such chemical additives may have diverse or substantially different sizes and/or chemical properties. To illustrate, certain accelerators, such as, for example, certain alkyl sulfonates or derivatives thereof, may have relatively low molecular weights (MW) that are less than about 200, whereas certain levelers, such as, for example, polyamides or derivatives thereof, may have considerably higher MW that are greater than 500, or greater than 1000. Furthermore, such chemical additives may have diverse chemical properties, such as, for example, ionizations, functional groups, polarities, optical properties, and the like. To illustrate, alkyl sulfonates or derivatives thereof may be highly ionized, whereas polyamides may be non-ionized.

Alternatively, the sample may be another type of chemical or biological sample but having multiple diverse analytes in the presence of a salt having a concentration that is higher than that of each of the analytes. For example, the sample may be an environmental sample (e.g., a contaminated water), a biological sample (e.g., urine, blood, etc.), a sample of a chemical synthesis solution, a sample from the chemical processing industries, or like samples from the chemical, environmental, biological, or analytical chemical arts.

As previously described, the sample may be introduced into the chromatograph. The chromatograph may represent an instrument or device to separate the components of the sample. Chromatography generally refers to a physical method of separation in which the components of the sample or mixture to be separated may be distributed or partitioned between different phases. One of the phases may be relatively stationary, and another of the phases may be mobile. Various different forms of chromatography are known in the arts and are suitable.

One form of chromatography that is well suited for separating components of a sample of a plating solution, and like samples, is liquid chromatography. In liquid chromatography a liquid referred to as an eluent is used for the mobile phase. The stationary phase is often contained within a column, in which case the liquid chromatography is a form of column chromatography. Examples of suitable forms of liquid chromatography include, but are not limited to, normal phase chromatography, reverse phase chromatography, size exclusion chromatography, ion exchange chromatography, and affinity chromatography.

In such various forms of liquid chromatography, analytes of the sample may be forced through the column or stationary phase with the liquid or eluent at high pressure. In such cases, the liquid chromatography is referred to as high-pressure liquid chromatography (HPLC). High-pressure liquid chromatography is sometimes called high-performance liquid chromatography. The high pressure may help to reduce the amount of time the analytes remain on the stationary phase, and the time the analytes have to diffuse within the column. This may help to improve resolution of the resulting chromatogram. However, the use of HPLC or high pressure is not required.

High performance liquid chromatographs (HPLCs) are commercially available from numerous sources. One particular example of a suitable HPLC is the UltiMate™ 3000 analytical system, which is commercially available from Dionex Corporation, of Sunnyvale, Calif. The HPLC may be equipped with a polymeric material packing having a mixture of hydrophobic and hydrophilic surfaces. A potential advantage of using this HPLC in the analysis of plating solutions in particular is that the internal tubing or sample pathways of the system are coated with polytetrafluoroethylene which allows greater compatibility with acids such as sulfuric acid. However, the use of this particular HPLC are not required. Other commercially available HPLCs may also optionally be used.

Referring again to FIG. 1, the analytes and the inorganic salt may be separated with the chromatograph, at block 104. After introducing the sample into the chromatograph, in liquid chromatography, an eluent or liquid may be used to elute or move the analytes or other components of the sample through the column or stationary phase. The diverse analytes or other components of the sample may interact differently with the stationary phase based on such characteristics as charge, solubility, size, adsorption, absorption, chemical interaction, or the like, depending upon the particular type of chromatography. The different interactions may result in the different analytes or other components being retained in the column or chromatograph for different lengths of time. That is, each of the components may have a different characteristic retention time in the column or chromatograph.

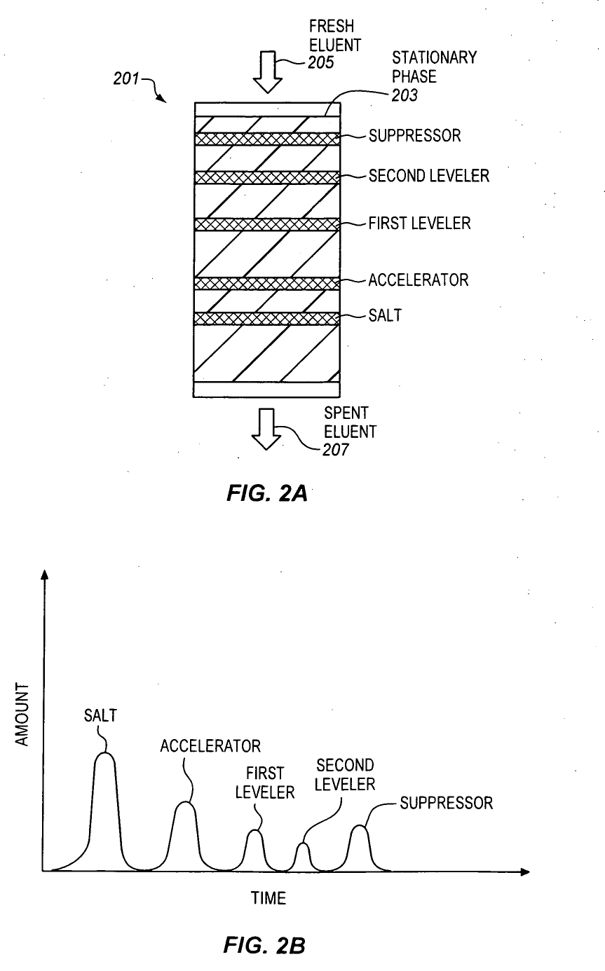

FIG. 2A conceptually illustrates separation of components in a liquid chromatography column 201, according to one or more embodiments of the invention. The column has a stationary phase 203 therein. By way of example, the stationary phase may include small beads or other packing that have been coated with a stationary phase material and then packed or placed in the column. During separation, fresh eluent 205 may be introduced into the top of the column, and an approximately equal amount of a spent eluent 207 may be removed from the bottom of the column. The eluent may flow through the column and force or move the components through the column subject to their different retention by the stationary phase.

In the illustration, five components, namely an inorganic salt, an accelerator, a first leveler, a second leveler, and a suppressor, have been separated in the liquid chromatography column. Each of the five components is included in a different region along the length of the column. Most of the salt in the sample is contained within a region labeled “salt”. Likewise, most of the accelerator, first leveler, second leveler, and suppressor are contained within the respectively labeled regions.

Eventually, each of the analytes or other components may be sequentially eluted or removed from the column by the eluent at different times after the initial introduction of the sample to the chromatograph. In this example, the salt may advance to the bottom of the column and be eluted first. Then, the accelerator may be eluted, followed in turn by the first leveler, then by the second leveler, and finally by the suppresser.

FIG. 2B is a chromatogram showing elution of components at different times from a chromatograph, according to one or more embodiments of the invention. The chromatogram plots amount of component eluted on the vertical axis, versus passage of time since sample introduction on the horizontal axis. In the illustrated chromatogram, the salt elutes first, followed in turn by the accelerator, then by the first leveler, then by the second leveler, and finally by the suppresser. As shown, each of the components may elute over a period of time. As further shown, the amount of the component in the eluent may vary over this period from near zero initially, to a maximum amount, and then to near zero again. The total amount of the component in the sample may be directly related to the integral or sum of the amounts eluted over this period of time in which the component is eluted.

As shown, the chromatographic separation may allow the inorganic salt to be separated from the chemical additives or other analytes of interest. Acid and/or base, if present, may be similarly separated from the analytes. In the chromatograph, the inorganic salt and the acid share the same peak. This may help to remove or at least reduce a matrix affect that would otherwise potentially hinder accurate measurement of the concentrations of the chemical additives.

To further illustrate certain concepts, elution of components of a plating solution have been shown and described. However the scope of the invention is not limited to just plating solutions. Components of other solutions may be similarly separated. Furthermore, the scope of the invention is not limited to the particular order in which the components are eluted. It should be appreciated that the order may depend upon various factors, such as, for example, the characteristics of the component, stationary phase, and eluent.

This is just a brief description of analysis with HPLC, which is well known in the arts. Further background information on HPLC, if desired, is widely available in the literature. One representative reference is the book “Modern HPLC for Practicing Scientists” by Michael W. Dong, published in 2006, by John Wiley and Sons, Inc. Hoboken N.J. (ISBN-13:978-0-471-72789-7).

Referring again to FIG. 1, the separated analytes may be introduced into an evaporative light scattering detector (ELSD), at block 106. In particular, each of the separated components may be introduced into the evaporative light scattering detector sequentially, or at least separately, along with the respective eluent fractions (liquid) within which they were eluted from the chromatograph. The copper salt and acid may or may not be analyzed by the ELSD. The concentrations of the copper salt and acid in the plating solution may often be determined by other approaches.

ELSD are commercially available from various sources. One particular example of a suitable ELSD is the PL-ELS 1000, which is commercially available from Polymer Laboratories, of Amherst, Mass. This system tends to be reliable, user friendly to operate, and may come available with software that is compatible with the UltiMate™ 3000 analytical system. However, the use of this particular ELSD is not required. Other commercially available ELSD may optionally be used.

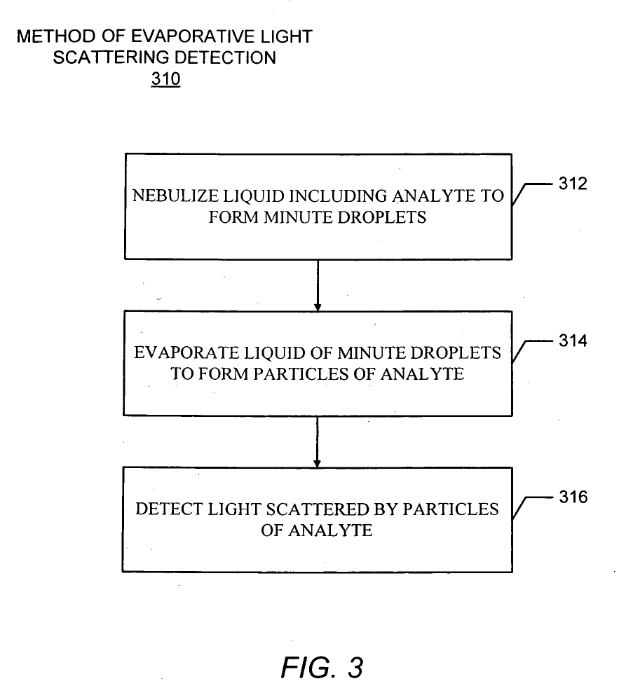

Then, the amounts of each of the analytes in the sample may be determined with the ELSD, at block 108. FIG. 3 is a block flow diagram illustrating a method of evaporative light scattering detection (ELSD) 310, according to one or more embodiments of the invention. The method is shown in basic form, although additional operations may optionally be added to the method.

A liquid or eluent fraction including one of the separated analytes from the chromatograph may be nebulized, at block 312. By way of example, the liquid including the analyte may be passed under pressure through a needle, or like nebulizer, and mixed with a gas, such as, for example, nitrogen, a noble gas, or another gas. This may cause an aerosol or dispersion of minute droplets of the liquid to form. The droplets may include the analyte of interest. In some but not all ELSD, a fraction of the largest droplets may be removed, for example by directing the aerosol through a curved path, although this is not required.

The liquid of the aerosol or droplets may then be evaporated or vaporized to form particles of the analyte of interest, at block 314. By way of example, the aerosol or nebulized droplets may be passed through a drift tube or other heated portion of the ELSD where the liquid may evaporate. The temperature to which the droplets are heated may be sufficient to evaporate the mobile phase, while not evaporating the analyte of interest. Commonly, the temperature ranges from near ambient to about 300° C. In the analysis of a plating solution, depending in part upon the particular eluent, the temperature often ranges from about 50° C. to about 110° C. Accordingly, the evaporating liquid may be selected based on both its ability to sufficiently separate the analytes during liquid chromatography and its ability to sufficiently evaporate during ELSD.

Such evaporation of the liquid may cause minute particles of the analyte of interest to form. Since detection in ELSD is based on total non-volatile mass under the conditions used for evaporation, it is generally desirable if the analyte of interest is introduced into the ELSD free of other components that would similarly be non-volatile under those conditions in order to get an accurate estimate of the analyte alone.

A beam of light may be shined on the minute particles of the analyte of interest, and light scattered by the particles may be detected, at block 316. By way of example, the particles of the analyte may be passed through an optical cell or other detection portion of the ELSD where a light source, for example a laser diode or other semiconductor laser, may shine a beam of light on the particles. The particles may scatter the photons of the beam of light. A light detector, such as, for example, a photodiode, photomultiplier tube, phototransistor, or the like, may detect the scattered light.

The amount of scattered light detected may be directly related to the amount of the analyte of interest presently in the detection portion of the ELSD. The total amount of the analyte of interest in the sample may be determined based on the integral, sum, or other combination over time of the amounts of scattered light detected for the entire fraction of eluent used to elute the analyte of interest from the chromatograph. These relations are well known and are frequently programmed into the ELSD or may be provided in separate software programs.

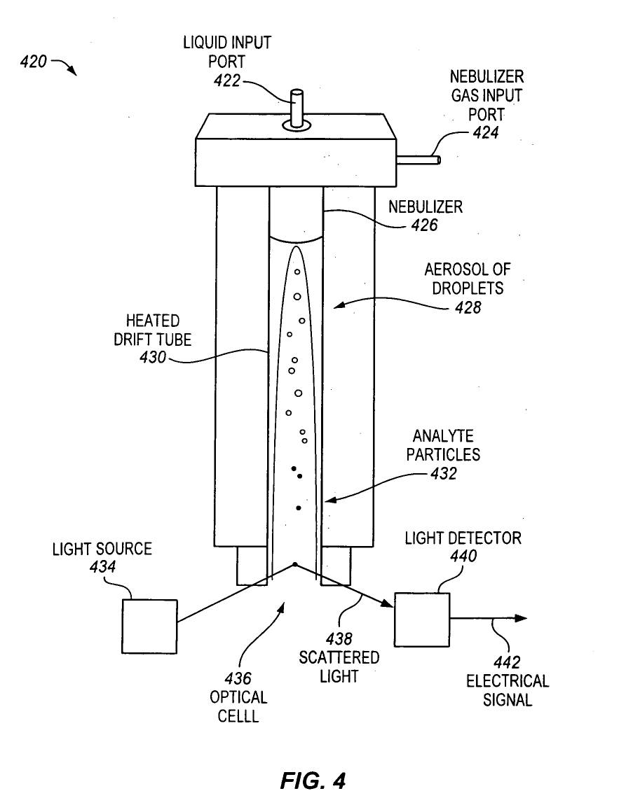

FIG. 4 is a sectional perspective view of a simplified illustrative evaporative light scattering detector (ELSD) 420, according to one or more embodiments of the invention. It should be appreciated that the sizes, shapes, and overall look of ELSD may vary considerably depending upon their design.

The ELSD includes a liquid input port 422 to receive a mobile phase, eluent, or other liquid having an analyte of interest. In one aspect, the liquid input port may be coupled or directly connected with an output of the chromatograph. Nitrogen, a noble gas, or another appropriate nebulizer gas, may be provided through a nebulizer gas input port 424. The liquid and the nebulizer gas may be directed through a needle, or other nebulizer 426, which may nebulize the liquid to form an aerosol of minute droplets 428.

The aerosol of minute droplets may flow through a heated drift tube 430, or other heated portion of the ELSD. The mobile phase or eluent of the liquid may evaporate causing minute particles 432 of the analyte to form in the ELSD.

A light source 434, such as, for example, a laser diode, or other semiconductor laser, may shine a beam of light on the particles of the analyte in an optical cell 436 or other detection portion of the ELSD. The analyte particles in the path of the beam of light may scatter a portion of the beam of light. A light detector 440, such as, for example, a photodiode, phototransistor, photomultiplier tube, or the like, may detect the scattered light 438. The light detector may generate a corresponding electrical signal 442. The magnitude of the electrical signal may be directly related to the amount of light detected.

Such electrical signals may be determined for the entire eluent fraction used to elute the analyte from the chromatograph. The electrical signals may then be integrated, summed, or otherwise combined over the entire eluent fraction that eluted the analyte of interest from the column in order to determine the total mass or other amount of analyte of interest in the sample. This approach may then be repeated sequentially, or at least separately, for each of the other analytes of interest in the sample.

Now, one advantage of using ELSD for detection is that the amount of light scattered by the particles tends to be relatively insensitive to the optical and chemical properties of the analyte of which the particles are made. This in part allows the ELSD to be used to detect a wide variety of analytes having diverse sizes, functional groups, and chemical properties, as long as the analytes are sufficiently non-volatile to allow the eluent or mobile phase to be evaporated so that particles of the analyte may form within the ELSD. Other detectors, such as, for example, ultraviolet (UV) detectors and fluorescence detectors, tend to be more dependent on the optical properties of the analyte, and tend to face difficulties with non-chromophoric analytes. As a result, if any of the multiple diverse analytes to be detected is non-chromophoric, such as, for example, not easily detected by UV, then multiple detection methods may be needed. This may tend to increase the cost and complexity of the analysis. Furthermore, this may be undesirable if the analysis is used for frequent process monitoring. However, using ELSD allows multiple diverse analytes to be analyzed using a single technique in a rapid and robust enough approach for in-line frequent process monitoring.

This is just a brief description of ELSD analysis, which is well known in the arts. Further background information on ELSD, if desired, is widely available in the literature. One representative reference is “Principles of Operation of an Evaporative Light-Scattering Detector for Liquid Chromatograph”, by Mourey, T. H. et al., published in Anal. Chem. (1984), 56:2427-2434. Another representative reference is “Effect of the Nature of the Solvent and Solutes on the Response of a Light-Scattering Detector”, by Righezza, M. et al., published in the Journal of Liquid Chromotography, (1988) 11:1967-2004.

In short, the chromatograph may selectively delay the analytes by different amounts of time so that the analytes elute at different times. The chromatograph may also separate the salt, acid, or other matrix affect from the analytes of interest. The characteristic elution time may in part identify the analytes. Then, the ELSD may separately determine the amounts of each of the analytes in the sample. The amount determined by the ELSD tends to be relatively insensitive to the chemical and optical properties of the analytes of interest and may allow a wide variety of diverse analytes to be sufficiently analyzed using a single, relatively rapid and robust technique.

To further illustrate certain concepts and allow one skilled in the art to better utilize the invention, consider a detailed working example of analysis of a plating solution. It is to be understood that this example is to be construed as merely illustrative, and not limiting on the scope of the invention.

Samples of an electroplating solution have been analyzed using the approaches described herein. The electroplating solutions generally had about 20-80 g/L of copper sulfate (the salt of the plating metal), about 20-180 g/L of 98% sulfuric acid, about 10-1000 mg/L of an accelerator, about 10-1000 mg/L of a leveler, about 10-1000 mg/L of a second leveler, and about 10-1000 mg/L of a suppresser.

About 50 microliter (μL) samples of the electroplating solution were introduced into the UltiMate™ 3000 brand HPLC from Dionex Corporation. The column included a resin-based packing that was coated with a poly(styrene-divinylbenzene) stationary phase.

Gradient elution was used to elute the analytes over about 20 minutes. The eluent flow rate was about 0.2 to 1.5 ml/min for this sample volume. Different mixtures of three different eluents were used. The three eluents included water as a first eluent, a second organic solvent eluent selected from tetrahydrofuran, acetonitrile (CH₃CN), ethanol, acetone, and mixtures thereof, and a third organic acid eluent selected from methanesulfonic acid, formic acid, trifluoroacetic acid, and mixtures thereof. The first eluent (water) in the mixture ranged from 25-70%, the second organic solvent eluent ranged from 10-40%, and the third organic acid eluent ranged from 20-35%. The percentage of the first eluent started high, was reduced, and then brought back high. The percentages of the second and third eluents started low, were increased, and then were brought back low.

The copper sulfate and acid eluted from the column from about 2 to 4 minutes after sample injection. The accelerator eluted from the column between about 5 to 6 minutes after sample injection. The first leveler eluted at about 9 minutes after sample injection. The second leveler, the byproduct of the first leveler, eluted between about 10 to 11 minutes after sample injection. The suppresser eluted about 12 minutes after sample injection.

The eluted analytes in the eluent fractions used to elute them were provided to the ELSD. The ELSD system used was a PL-ELS 1000 from Polymer Laboratories. The ELSD was operated with a nebulizer flow rate of nitrogen of about 1 cubic centimeter per minute. The nebulizer temperature was about 30-150° C., depending upon the eluent. The evaporating temperature was about 70-270° C., depending upon the eluent.

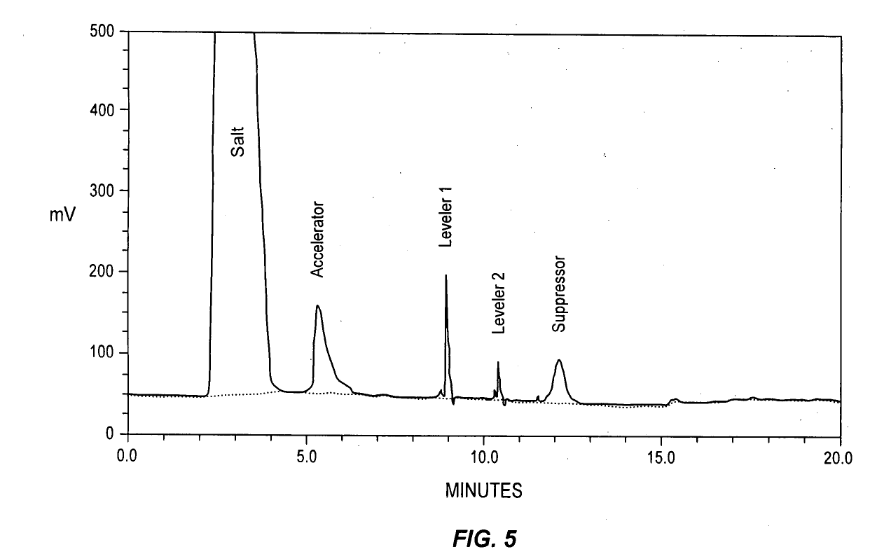

FIG. 5 is a chromatogram showing the amounts of the components of the plating solution determined by the above-described analysis, according to one or more embodiments of the invention. The amounts of the accelerator, levelers, and suppresser sufficiently estimated the actual amounts known to be in the sample. As shown, even though the analytes are diverse in size and chemical properties, they were adequately detected using ELSD. Even the accelerator, which was a small organic molecule having a molecular weight of only around 100, was adequately detected using ELSD. It is believed that separating the copper sulfate and sulfuric acid from the other analytes helped to reduce a matrix affect and promote accurate determination of the amounts of the analytes.

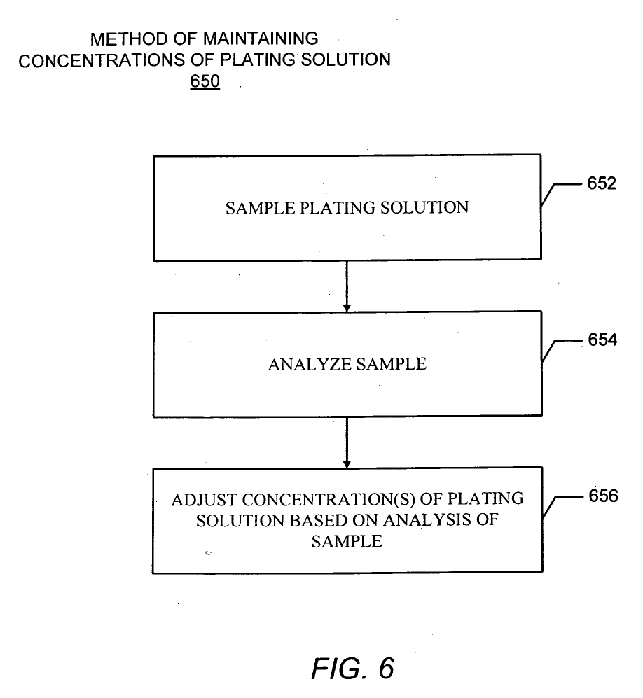

FIG. 6 is a block flow diagram illustrating a method of adjusting concentration(s) of a plating solution based on sample analysis, according to one or more embodiments of the invention. The plating solution may be sampled, at block 652. In one or more embodiments of the invention, the sampling of the plating solution may be performed autonomously by an in-line process monitor at a scheduled time. Alternatively, in one or more embodiments of the invention, a technician may sample the plating solution at a scheduled time.

Then, the sample may be analyzed, at block 654. The sample may be analyzed as previously described. For example, in one or more embodiments of the invention, analyzing the sample may include introducing the sample into a liquid chromatograph, separating the analytes and other components of the sample in the liquid chromatograph, introducing the separated analytes into an evaporative light scattering detector (ELSD), and determining the amounts of the analytes in the sample with the ELSD. The chromatograph may separate salts, acids, bases, or other components that would otherwise potentially provide a matrix affect if not separated. The ELSD may determine amounts of diverse sized and/or propertied analytes relatively independently of their optical and chemical properties.

Then, one or more concentration(s) of the plating solution may be adjusted based on the analysis of the sample, at block 656. For example, if an amount of an analyte in the sample is determined to be less than intended, then additional chemical corresponding to the analyte may be added to the plating solution. In one or more embodiments of the invention, the adjustment of the concentration of the plating solution may be performed autonomously by control of a chemical addition system. Alternatively, in one or more embodiments of the invention, an operator or technician may adjust the concentration of the plating solution.

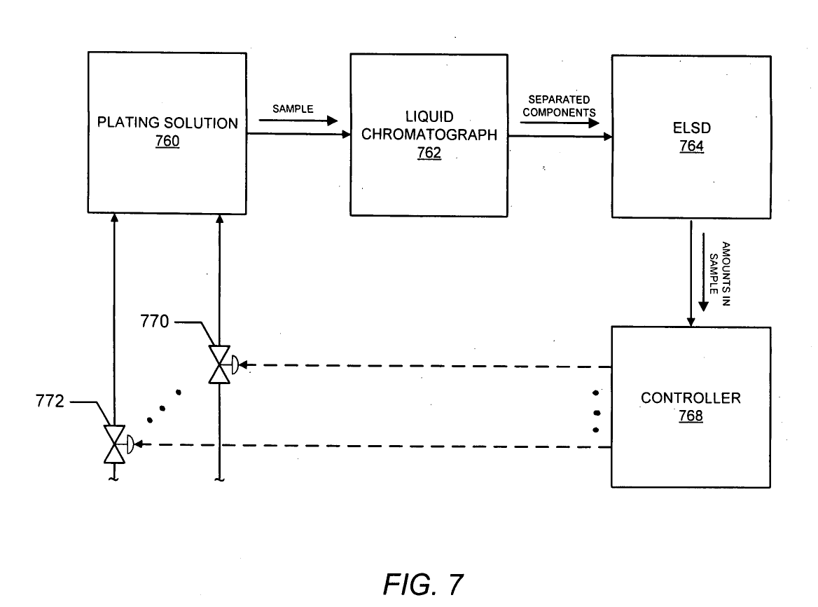

FIG. 7 is a block diagram of a system to analyze and adjust concentration(s) of a plating solution, according to one or more embodiments of the invention. The system includes a plating solution 760. In one or more embodiments of the invention, the plating solution may include an electroplating solution. Alternatively, in one or more embodiments of the invention, the plating solution may include an electroplating solution.

The system further includes a liquid chromatograph 762 to receive a sample of the plating solution. In one or more embodiments of the invention, the liquid chromatograph may be fluidically coupled with the plating solution through a sample feed line to receive the sample. Alternatively, an operator or technician may derive the sample from the plating solution and introduce the sample into the liquid chromatograph. The liquid chromatograph may separate the components of the sample of the plating solution as previously described.

An ELSD may be fluidically coupled with the output of the liquid chromatograph to receive the separated components in sequential order. Alternatively, an operator or technician may transfer the separated components to the ELSD. The ELSD may analyze the separated components as previously described. The ELSD may determine the amounts of the analytes of interest in the sample.

The ELSD may provide the amounts of the analytes of interest to a controller 768. The controller may be implemented as a process controller or as a general-purpose computer system running quality control software, to name just a few examples. The controller may compare the determined amounts of each of the analytes of interest with corresponding intended amounts. If an amount of an analyte of interest is determined to be sufficiently or substantially less than the intended amount, the controller may control addition of a chemical additive corresponding to the analyte to the plating solution. In one aspect, the adjustment may only be performed if the difference is greater than a threshold to avoid thrashing or over-adjustment.

An addition system may be used to adjust concentration(s) of the plating solution. As shown in the illustrated embodiment, the controller may control valves 770, 772 or other flow regulators to allow chemical additives corresponding to the analytes that are low to be added to the plating solution. In one or more embodiments of the invention, each of the analytes of interest may have a separate valve or may otherwise be controlled separately. Alternatively, the controller may provide a signal to an operator to adjust the concentration.

The approaches described herein may allow accurate determination of the concentrations of chemical additives in plating solutions. Advantageously, this may help to avoid unnecessarily discarding electroplating solutions relatively frequently because the concentrations of the additives are not adequately known, which may help to reduce operating costs and environmental impact.

In one or more other embodiments of the invention, the approaches described herein may also be used to verify or validate the concentrations of an incoming or fresh plating solution. Other methods of using the approaches described herein are also contemplated.

While embodiments of the invention have been described in the context of plating solutions for the semiconductor processing industry, the scope of the invention is not so limited. Alternate embodiments of the invention are suitable for analysis of a wide variety of solutions in the broader chemical and biotech industries. For example, one of the alkyl sulfonate derivative accelerator chemicals tested has properties relatively similar to those of certain salts, soaps, surfactants, and detergents. As another example, one of the polyamide leveler chemicals tested has properties relatively similar to those of certain nylons and proteins. Accordingly, proteins, peptides, amino acid polymers, and other biological molecules are suitable analytes. As yet another example, one of the polyether complex suppressor chemicals tested has properties relatively similar to those of certain phase transfer agents and miscelle agents. Accordingly, it is contemplated that the approaches described herein may be utilized to analyze a wide variety of mixtures including one or more salts, soaps, surfactants, detergents, nylons, proteins, phase transfer agents, and miscelle agents, potentially along with other diverse chemicals. In general, the approaches described herein may offer particular advantages when analyzing mixtures of analytes having diverse sizes and properties in the presence of a salt or other matrix affect.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known devices and operations have been shown in block diagram form or without detail in order to avoid obscuring the understanding of the description.

It will also be appreciated, by one skilled in the art, that modifications may be made to the embodiments disclosed herein, such as, for example, to the sizes, shapes, configurations, forms, functions, materials, and manner of operation, and assembly and use, of the components of the embodiments. All equivalent relationships to those illustrated in the drawings and described in the specification are encompassed within embodiments of the invention.

Various operations and methods have been described. The methods have generally been described in a basic form, but operations may optionally be added to the methods.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Accordingly, while the invention has been thoroughly described in terms of several embodiments, those skilled in the art will recognize that the invention is not limited to the particular embodiments described, but may be practiced with modification and alteration within the spirit and scope of the appended claims. The description is thus to be regarded as illustrative instead of limiting.

What is claimed is:

1. A method comprising:
introducing a sample of a plating solution into a liquid chromatograph, wherein the plating solution includes a salt of a plating metal and a plurality of chemical additives;
separating the salt and each of the chemical additives with the liquid chromatograph;
introducing the separated chemical additives into an evaporative light scattering detector (ELSD); and
determining amounts of each of the chemical additives in the sample with the ELSD.

2. The method of claim 1, wherein said introducing the sample into the liquid chromatograph comprises introducing a first chemical additive having a molecular weight (MW) that is less than 200 and a second chemical additive having a MW that is greater than 500 into the liquid chromatograph.

3. The method of claim 1, wherein said introducing the sample into the liquid chromatograph comprises introducing an accelerator chemical, a leveler chemical, and a suppresser chemical into the liquid chromatograph.

4. The method of claim 3, wherein the accelerator chemical comprises one or more selected from bisulfonates and derivatives thereof, alkyl sulfonates and derivatives thereof, pyridines and derivatives thereof, wherein the leveler chemical comprises one or more selected from polyamides and derivatives thereof, polyamines and derivatives thereof, and polyimines and derivatives thereof, and wherein the suppresser chemical comprises one or more selected from polysilyl complexes and derivatives thereof, polyether complexes and derivatives thereof, and polycyclic macrolyte complexes and derivatives thereof.

5. The method of claim 1, wherein said determining the amounts comprises nebulizing liquids each containing one of the chemical additives, evaporating the liquids to form particles of the respective chemical additives, and detecting light scattered by the particles.

6. The method of claim 1, wherein said separating comprises flowing a mixture of water, an organic solvent, and an organic acid through the liquid chromatograph as an eluent.

7. The method of claim 6, wherein said determining the amounts comprises evaporating the eluent at a temperature ranging from 70 to 270° C.

8. The method of claim 1, further comprising:
deriving the sample from a manufacturing process; and
adding a chemical additive to the plating solution if the determined amount of the chemical additive is less than an intended amount.

9. A method comprising:
introducing a sample into a chromatograph, the sample including a plurality of analytes having diverse sizes and chemical properties in solution with a salt having a concentration that is higher than that of each of the analytes;
separating the analytes and the salt with the chromatograph;
introducing the separated analytes into an evaporative light scattering detector (ELSD); and
determining amounts of each of the analytes in the sample with the ELSD.

10. The method of claim 9, wherein said introducing the sample into the chromatograph comprises introducing a high molecular weight (MW) compound having a MW that is greater than 500 and a low MW compound having a MW that is less than 200 into the chromatograph

11. The method of claim 9, wherein said introducing the sample into the chromatograph comprises introducing a sample having at least 0.05 mol/L of the salt.

12. The method of claim 9, wherein said determining the amounts comprises nebulizing liquids each containing one of the analytes, evaporating the liquids to form particles of the respective analytes, and detecting light scattered by the particles.

13. The method of claim 9, wherein said separating comprises flowing a mixture of water, an organic solvent, and an organic acid as an eluent through the chromatograph.

14. The method of claim 13, wherein said determining the amounts comprises evaporating the eluent at a temperature ranging from 70 to 270° C.

15. The method of claim 9, wherein said introducing the sample into the chromatograph comprises introducing a sample of a plating solution into the chromatograph, wherein the salt comprises a salt of a plating metal, and wherein the analytes comprise two or more of an accelerator, a leveler, and a suppresser.

16. The method of claim 15, further comprising adding a compound to the plating solution if the determined amount of a corresponding analyte is less than an intended amount.

17. The method of claim 9, wherein at least one of the analytes comprises a biological molecule.

18. A system comprising:
a plating bath;
an in-line monitor for the plating bath, the in-line monitor including:
a chromatograph to separate components of a sample of the plating bath; and
an evaporative light scattering detector (ELSD) coupled with an output of the chromatograph, the ELSD to determine amounts of the separated components in the sample.

19. The system of claim 18, wherein the chromatograph is coupled with the plating bath by a sample feed line.

20. The system of claim 18, wherein the chromatograph comprises a high-performance liquid chromatograph.

21. The system of claim 18, further comprising:
an addition system coupled with the plating bath to add a chemical additive to the plating bath; and
a controller to cause the addition system to add a chemical additive to the plating bath if an amount of a corresponding component is determined to be less than an intended amount.
